(19) United States
(12) Patent Application Publication
(10) Pub. No.: US 2005/0050153 A1
(43) Pub. Date: Mar. 3, 2005

(54) NETWORK EQUIPMENT MANAGEMENT SYSTEM AND RELATED METHOD

(76) Inventors: Ta-Wen Tai, Hsin-Chu City (TW); Chien-Chung Tai, Hsin-Chu City (TW)

Correspondence Address: (NAIPC) NORTH AMERICA INTERNATIONAL PATENT OFFICE, P.O. BOX 506, MERRIFIELD, VA, 22116, US

(21) Appl. No.: 10/707,397

(22) Filed: Dec. 10, 2003

(30) Foreign Application Priority Data
Sep. 3, 2003 (TW) 092124390

(51) Int. Cl. G06F 15/16

(52) U.S. Cl. 709/208; 709/219; 709/246

(57) ABSTRACT

A network equipment management system comprises a plurality of network equipment, a management computer for managing the network equipments, and a management agent coupled between the management computer and the network equipments, wherein the job of the management agent is to represent the management computer and to manage the network equipment for the management computer. When the management computer sends a managing packet to the management agent, the management agent changes the address information contained in the managing packet to generate an agent managing packet and sends the agent managing packet to a first network equipment of the network equipment. When the first network equipment sends a replying packet to the management agent, the management agent changes the address information contained in the replying packet to generate an agent replying packet and sends the agent replying packet to the management computer.

### BACKGROUND OF INVENTION

1. Field of the Invention

The invention relates to a network equipment management system, and more particularly, to a network equipment management system wherein a management computer can manage a plurality of network equipment through a management agent.

2. Description of the Prior Art

Recently, the developing speed of the Internet has been very fast. Many kinds of network equipment have been proposed, parts of the network equipment can be controlled remotely (such as many kinds of server), and a system manager can use a management computer to manage these kinds of network equipment through the Internet.

Please refer to FIG. 1, where a conventional network equipment management system is illustrated. A management computer 110 used by a system manager can connect to a plurality of network equipment 150a-d (in this example there are four pieces of network equipment) through the Internet 120. Each one of the network equipment 150a-d has its own real IP address; the management computer can use these real IP addresses to communicate with and manage the network equipment 150a-d.

For example, imagine that the real IP address of the management computer is (140.112.30.142) while the real IP addresses of the network equipment 150a-d are (140.125.10.10), (140.125.10.20), (140.125.10.30), and (140.125.10.40) respectively. When the management computer 110 wants to start managing the network equipment 150a, the management computer 110 should first open one or more managing windows (a managing window must be opened while a different protocol is used) for connecting to and managing the network equipment 150a. During the managing process, the management computer 110 sends out one or more managing packets to the network equipment 150a; the source address of these managing packets is the IP address (140.112.30.142) of the management computer 110. The destination address of these managing packets is the IP address (140.125.10.10) of the network equipment 150a. The port number of these packets normally will be determined by the used protocol (for example, the default port of the HTTP protocol is 80 while the default port of the TELNET protocol is 23).

After the network equipment 150a has received these managing packets, it will perform corresponding operations according to these managing packets. If it is necessary, the network equipment 150a will send out one or more replying packets to the management computer 110. The source address of these replying packets is the IP address (140.125.10.10) of the network equipment 150a. The destination address of these replying packets is the IP address (140.112.30.142) of the management computer 110. Of course, these replying packets will be sent to the management computer 110 through the Internet 120.

Under the configuration shown in FIG. 1, when the management computer 110 manages a network equipment, one specific IP address must be used as the destination address for every managing packet. Hence, the system manager using the management computer 110 must keep firmly in mind each IP address of the network equipment 150a-d; this causes a certain load on the system manager. Also, because the Internet is blooming, the number of real IP addresses is becoming scarce. As a result, it is not practical to let each network equipment has its own real IP address. Although lots of proposed technologies transform real IP addresses and private IP addresses, the system manager still has to keep firmly in mind each IP address of the managed network equipments. That is the main problem of the prior art.

### SUMMARY OF INVENTION

It is therefore a primary objective of the present invention to provide a network equipment management system wherein a management computer can manage a plurality of network equipments via a management agent to solve the above-mentioned problem.

According to the claimed invention, a network equipment management system is proposed. The network equipment management system comprises: a plurality of network equipment; a management computer for managing the network equipment; and a management agent, coupled between the network equipment and the management computer, for representing the management computer in managing the network equipments. When the management agent receives a managing packet sent by the management computer, the management agent changes the address information of the managing packet to generate an agent managing packet and sends the agent managing packet to a first network equipment. When the management agent receives a replying packet sent by the first network equipment, the management agent changes the address information of the replying packet to generate an agent replying packet and sends the agent replying packet to the management computer.

It is an advantage of the claimed invention that a system manager using the management computer only has to use the real IP address of the management agent as the destination address to manage any of the network equipment connected to the management agent. It is more convenient than that of the prior art.

It is another advantage of the claimed invention that all of the managed network equipment use only private IP addresses. By using private IP addresses, the system manager using the management computer can still manage the network equipments via the management agent while reducing the number of real IP addresses needed.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a conventional network equipment management system 100.

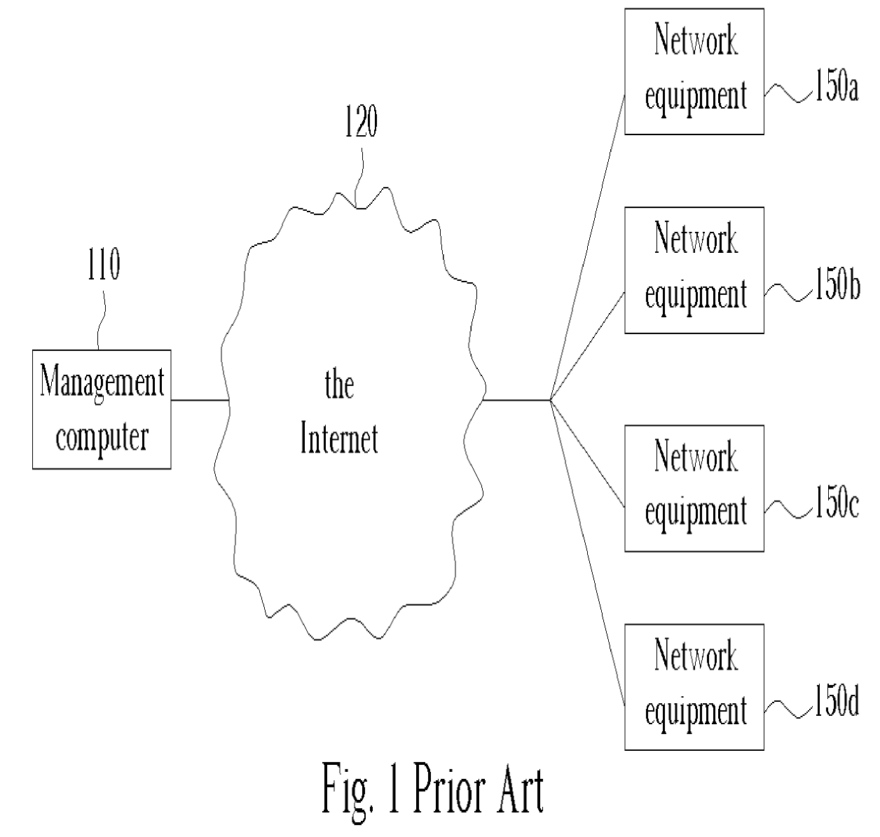

FIG. 2 is a network equipment management system 200 according to the present invention.

### DETAILED DESCRIPTION

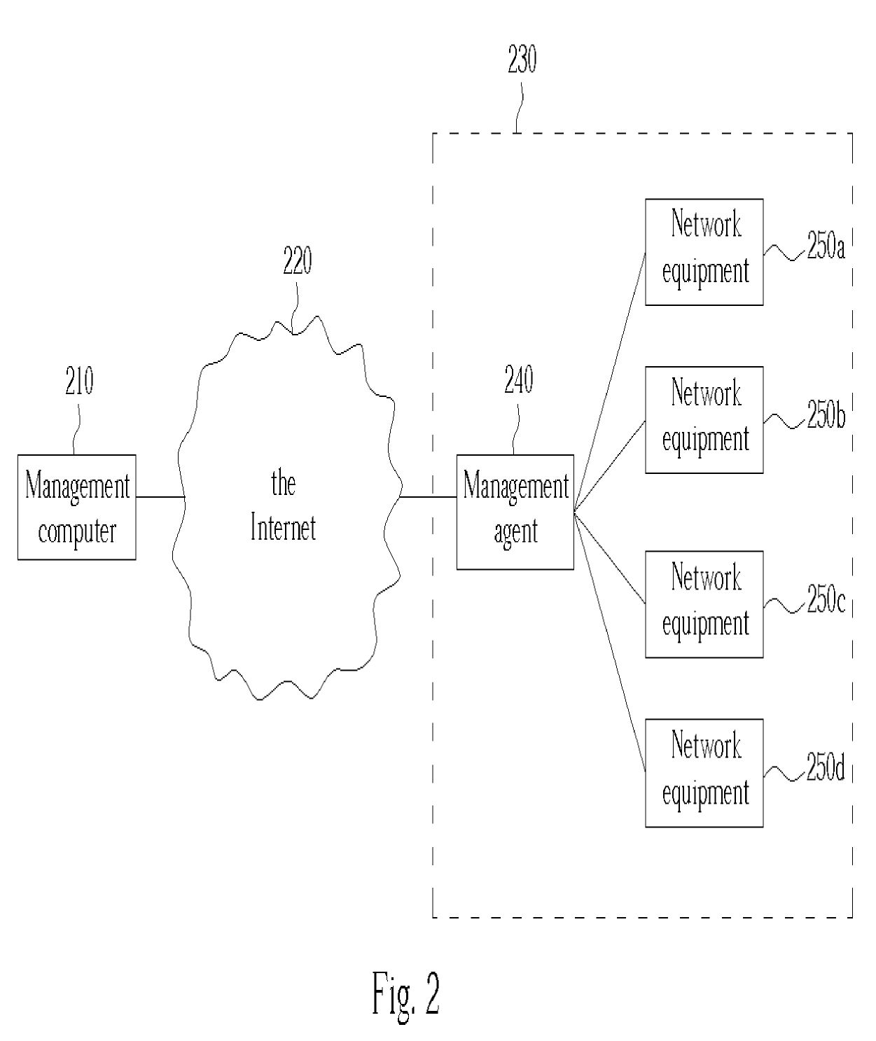

Please refer to FIG. 2, where an embodiment network equipment management system of the present invention is illustrated. In this embodiment, the real IP address of the management computer 210 is (140.112.30.142), and the management computer 210 can connect to the local area network 230 through the Internet 220. The local area network 230 comprises a management agent 240 and a plurality of network equipment 250a-d (in this embodiment there are four pieces of network equipment). The management agent 240 has a real IP address (140.125.10.10) and a private IP address (23.25.27.05). The real IP address (140.125.10.10) is what the management agent 240 uses to communicate with the Internet 220 while the private IP address (23.25.27.5) is what the management agent 240 uses to communicate with other equipment in the local area network 230 (such as the network equipments 250a-d). As for the network equipment 250a-d, each one has a private IP address (23.25.27.10), (23.25.27.20), (23.25.27.30), (23.25.27.40) respectively. Under such configuration, the system manager using the management computer 210 can use the real IP address (140.125.10.10) of the agent management computer 240 to manage each of the network equipments 250a-d. The details shall be clear after following the detailed description.

When the system manager using the management computer 210 wants to manage any one of the network equipment 250a-d, the management computer 210 must first connect to the management agent 240 through the Internet 220 (using the real IP address of the management agent 240 as the destination address). After the connection has been established, the management agent 240 sends the state information about the network equipment 250a-d to the management computer 210 (probably some configuration on the management agent 240 must be done before this). Then, a controlling window will be shown on a screen of the management computer 210 to reveal the state information about the network equipment 250a-d. If the desired managing target of the system manager is the network equipment 250a, he or she simply chooses the network equipment 250a via the controlling window. At this time, the management computer 210 sends one or more controlling packets (all these controlling packets have a specific port number in order to be distinguished from other kind of packets) to the management agent 240, telling the management agent 240 that the network equipment 250a is the currently desired managing target.

Later, the management computer 210 shows one or more managing windows on the screen (each managing window is for one protocol used in the management of the network equipment 250a) and starts to use some protocols (for example: the HTTP protocol, the TELNET protocol, or the SNMP protocol) to manage the network equipment 250a. During the managing process, the management computer 210 sends out one or more managing packets; the source address of these managing packets is the real IP address (140.112.30.142) of the management computer 210 while the destination address is the real IP address (140.125.10.10) of the management agent 240 (please note that it's not the IP address of the network equipment 250a).

When the management agent 240 receives these managing packets, the management agent 240 already knows that the desired target is the network equipment 250a (through the controlling packets), so the management agent 240 will change the address information of these managing packets (but the port number remains unchanged, so the used protocol is still the same). The source address will be changed from (140.112.30.142) to the private IP address (23.25.27.5) of the management agent 240 while the destination address will be changed from (140.125.10.10) to the private IP address (23.25.27.10) of the network equipment 250a. One or more agent managing packets will hence be generated, and these agent managing packets will be sent to the network equipment 250a.

After the network equipment 250a has received these agent managing packets, some corresponding operations will be performed. If its necessary, the network equipment 250a will send out one or more replying packets to report the results or corresponding information to the management computer 210. The source address of these replying packets is the private IP address (23.25.27.10) of the network equipment 250a while the destination address is the private IP address (23.25.27.5) of the management agent 240 (please note that its not the IP address of the management computer 210). When the management agent 240 receives these replying packets, the management agent 240 will change the address information of these replying packets. The source address will be changed from (23.25.27.10) to the real IP address (140.125.10.10) of the management agent while the destination address will be changed from (23.25.27.5) to the real IP address (140.112.30.142) of the management computer 210. One or more agent replying packets will hence be generated. Then these agent replying packets will be sent to the management computer 210.

Under the configuration mentioned above, after the management computer 210 chooses a network equipment as the target management equipment through the controlling window (in the previous example, it was network equipment 250a), the management computer 210 can think of the real IP address (140.125.10.10) of the management agent as the IP address of the chosen network equipment 250a; all the managing packets will be sent to this address, and all the agent replying packets will be received from this address. As for the chosen network equipment 250a, all the agent managing packets will be received from the management agent 240, and all the replying packets will be sent to the management agent 240. So as far as the chosen network equipment 250a is concerned, the private IP address (23.25.27.5) of the management agent is the IP address of the management computer 210.

Of course, if the management computer 210 wants to change the managed network equipment (for example: network equipment 250d), the management computer 210 can choose the desired network equipment 250d through the controlling window. Then the management computer 210 will send another controlling packet or packets to the management agent 240, telling the management agent 240 that the network equipment 250d is now the chosen equipment (as mentioned before, the controlling packets have specific port number, such as port 30000). Afterwards, all the managing packets sent out by the management computer 210 will be sent to the management agent 240. The management agent 240 changes the address information of these managing packets to become one or more agent managing packets and then sends these agent managing packets to the network equipment 250d. At this time, the management computer 210 can think of the real IP address (140.125.10.10) of the management agent as the IP address of the network equipment 250d.

So with the configuration proposed by the present invention, the system manager only has to know the real IP address (140.125.10.10) of the management agent 240; he or she can use this real IP address to manage any one of the network equipment 250a-d connected to the management agent 240 without being concerned about the IP addresses used by the network equipment. The convenience during the process of management is hence upgraded. In addition, because each of the network equipment 250a-d uses only a private IP address to connect to the management agent 240 instead of occupying a real IP address, the number of real IP addresses needed can be reduced. Please note that the topology of the local area network 230 shown in FIG. 2 serves only as an example. In a real embodiment, any kind of topology can be used in the local area network to connect the equipment in the local area network 230.

In reality, the management agent 240 can be a refined network switch, embedded with program codes to perform the above-mentioned job. The configuration shown in FIG. 2 can also be broadened to a multi-layer agent management configuration; that is, one (or more) of the network equipment in the local area network 230 can be another management agent for representing the agent management agent 240 in managing other network equipment. In addition, with the progressing of technology, some information appliances (such as air conditioners, refrigerators, or televisions) can also be remotely controlled through the Internet. So with the proposed configuration, the managed network equipments not only can be various servers, network switches, routers, but they can also be any kind of information appliances. Users can use the management computer 210 to manage the network equipment 250a-d formed by information appliances via the management agent 240 through the Internet.

In contrast to the prior art, the network equipment management system of the present invention comprises a management agent, for representing a management computer to manage a plurality of network equipment. The system manager using the management computer can use the IP address of the management agent as the destination address to manage any one of the network equipment connected to the management agent. The managing process is more convenient than that of the prior art.

In addition, under the configuration proposed by the present invention, no special connection must be used to connect the network equipment; hence, the hardware cost will not be higher than that of the prior art. Also, it is not necessary to connect all of the network equipment together, so the whole system will not suffer from the limited identification numbers. Any kind of network equipment manufactured by different manufacturers can be managed under the proposed configuration.

Those skilled in the art will readily observe that numerous modification and alternation of the device may be made while retaining the teaching of the invention. Accordingly, the above disclosure should be construed as limited only by the metes and bounds of the appended claims.

1. A network equipment management system comprising:
a plurality of network equipments;
a management computer, for managing the network equipments; and
a management agent, coupled between the network equipments and the management computer, for representing the management computer to manage the network equipments;
wherein when the management agent receives a managing packet sent by the management computer, the management agent changes the address information of the managing packet to generate an agent managing packet, and sends the agent managing packet to a first network equipment; when the management agent receives a replying packet sent by the first network equipment, the management agent changes the address information of the replying packet to generate an agent replying packet, and sends the agent replying packet to the management computer.

2. The network equipment management system of claim 1, wherein the management agent and the network equipments are located in a local area network.

3. The network equipment management system of claim 2, wherein the management agent and the network equipments use private IP addresses to communicate with each other.

4. The network equipment management system of claim 1, wherein the management computer and the management agent use real IP addresses to communicate with each other through the Internet.

5. The network equipment management system of claim 1, wherein the network equipment management system uses the TELNET protocol.

6. The network equipment management system of claim 1, wherein the network equipment management system uses the HTTP protocol.

7. The network equipment management system of claim 1, wherein the network equipment management system uses the SNMP protocol.

8. The network equipment management system of claim 1, wherein the network equipments comprise network servers.

9. The network equipment management system of claim 1, wherein the network equipments comprise information appliances.

10. The network equipment management system of claim 1, wherein the network equipments comprise network switches.

11. The network equipment management system of claim 1, wherein the network equipments comprise routers.

12. A method for allowing a management computer to manage a plurality of network equipments in a network system, the method comprising:
(a)providing a management agent coupled between the management computer and the network equipments;
(b)sending a managing packet to the management agent with the management computer;
(c)changing the address information of the managing packet to generate an agent managing packet and then sending the agent managing packet to a first network equipment with the management agent; and
(d)performing corresponding operation(s) according to the agent managing packet with the first network equipment.

13. The method of claim 12, wherein in step (c), the management agent changes the source address and the destination address of the managing packet to become the IP address of the management agent and the IP address of the first network equipment respectively, to generate the agent managing packet.

14. The method of claim 12, further comprising:
(e)sending a replying packet to the management agent with the first network equipment; and
(f)changing the address information of the replying packet to generate an agent replying packet and then sending the agent replying packet to the management computer with the management agent.

15. The method of claim 14, wherein in step (f), the management agent changes the source address and the destination address of the replying packet to become the IP address of the management agent and the IP address of the management computer respectively, to generate the agent replying packet.

16. The method of claim 14, wherein in the agent managing packet and the replying packet, the source addresses and destination addresses are private IP addresses.

17. The method of claim 14, wherein in the managing packet and the agent replying packet, the source addresses and destination addresses are real IP addresses.

18. The method of claim 12, further comprising:
(g)using the management computer to establish a connection with the management agent through the Internet;
(h)after the connection between the management computer and the management agent has been established, sending status information of the network equipments to the management computer with the management agent; and
(i)showing the status information of the network equipments on a controlling window of a screen with the management computer.

19. The method of claim 18, further comprising:
(j)using the controlling window to choose a target network equipment within the network equipments with the management computer;
(h)setting the chosen network equipment as the first network equipment with the management agent; and
(j)showing a managing window on the screen for managing the first network equipment with the management computer.

20. The method of claim 12, wherein the method uses the TELNET protocol.

21. The method of claim 12, wherein the method uses the HTTP protocol.

22. The method of claim 12, wherein the method uses the SNMP protocol.
